(19) United States
(12) Patent Application Publication
(10) Pub. No.: US 2008/0228567 A1
(43) Pub. Date: Sep. 18, 2008

(54) ONLINE COUPON WALLET

(75) Inventors: Charles J. Williams, Redmond, WA (US); Sergey I. Bykov, Redmond, WA (US); Timothy E. Belvin, Woodinville, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/687,202

(22) Filed: Mar. 16, 2007

(51) Int. Cl. G06Q 30/00

(52) U.S. Cl. 705/14

(57) ABSTRACT

Systems and methods that electronically redeem coupons via an online storage component, which stores coupon data for a consumer and regardless of which issuer has issued the coupon. Such online storage medium can store coupons online (e.g., in a single location) without being tied to a particular service, and can readily provide redemption (e.g., an automatic redemption). The consumer and other retail entities (e.g., coupon issuers, merchants, and the like) can populate the online storage medium periodically, or in response to predetermined events (e.g., physical location of consumer, associated demographics, and the like.)

### BACKGROUND

Today, a typical purchase, which involves coupons, would include a customer clipping coupons at home, taking the coupons to the store, and selection of products for check out at a cashier station or point of sale (POS) terminal. Coupons are then redeemed by merchants via settlement thereof through clearing houses and submittal to coupon issuers.

In general, consumers receive coupons through a variety of channels such as: mailings, newspapers, showings on the product itself, or printed at a retail outlet. Moreover, newspapers and leaflets of coupons mailed or delivered to residences of customers still remains the most common channel for delivering coupons to customers. Such printed coupons are presented at the checkout station to obtain a discount on a product. The paper coupons are collected at the POS by the retailer and then sent to a clearinghouse, which in turn separates the coupons and bills respective coupon issuer for reimbursement of the retailer.

Such system has proven itself to cause problems for both the customers and retailers. For example, customers have to manually clip desired coupons and sort them by product categories (e.g., detergents, canned foods, cereals, frozen foods, toiletries, and the like) to efficiently find products when shopping at the store. Furthermore, customers have to periodically examine their collection of coupons and discard expired ones. Moreover, retailers also have to expend considerable hours and resources to sort through coupons by manufacturer for redemption, and monitor expired coupons at the checkout station.

Typically, coupons that are collected by a retailer are passed through a clearinghouse for assortment. Such clearinghouse can subsequently pay retailers cash for estimated value of the coupons, wherein a difference between the estimated and actual amount can later be credited or debited. Nevertheless, retailers are still required to monitor for expired coupons and handle coupon collection and submittal to the clearinghouse for payment.

Another problem of such paper coupon system is misredemption. For example, misredemption can occur when a consumer employs a coupon without purchasing an item associated therewith. Likewise, checkout clerks can inappropriately exploit such paper coupon system by interchanging coupons and cash. Misredemption of coupons is estimated to be as high as 20%-30%.

Furthermore, conventional payment shopping systems cannot efficiently process coupons associated with electronic purchase transactions. For example, coupons in such systems are not centrally stored, and are typically tied to particular services.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject invention provides for shopping network systems and methods that electronically redeem coupons, via an online storage location that stores coupon data for a consumer and regardless of which issuer has issued the coupon. Accordingly, such online storage medium can store coupons online (e.g., in a single location) without being tied to a particular service, and can readily provide redemption (e.g., an automatic redemption). The consumer and other retail entities (e.g., coupon issuers, merchants, and the like) can populate the online storage medium periodically, or in response to predetermined events (e.g., physical location of consumer, associated demographics, and the like.)

In a related aspect, the online storage medium functions as an online service wherein users (e.g., consumers) can aggregate coupons collected from a plurality of channels (e.g., paper coupons, electronic coupons) therein—via submission thru the web. Such service can organize collected coupons, facilitate a search thereof, and mange redemption and access to the collected coupons. During a purchase transaction, users redeem coupons that are related to the purchase via an identification process, wherein the point of sale (POS) terminal receives such coupons, (e.g., via direct access to the online storage location, and/or via user submittal), and can apply them to the user's shopping basket at checkout. Items in basket of the consumer can be matched with coupons and rules relating thereto (e.g., discourage using the coupons for the same identical transaction).

According to a related methodology, users can sign up for such service and receive an account coupled to their identity (e.g., a user name, account number, password, and the like), and can subsequently login to the service with credentials from a web browser, desktop or mobile (cell phone) applications. Subsequently, and upon a successful login, a user can view all coupons stored on the account organized by products, stores, expiration, and the like. Moreover, additional coupons can be stored by uploading an electronic coupon, image of a coupon (collected via smart phone's built-in camera), reading an RFID tag, and related methods of updating data. The service can keep track of submitted coupons, their expiration dates, automatically delete expired once and remind about those expiring soon.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of a business commerce network with an online storage location in accordance with an aspect of the subject innovation.

FIG. 2 illustrates a system that facilitates allocation of various resource(s) of the online storage component based on requirements for coupon processing for each consumer.

FIG. 3 illustrates a methodology of aggregating coupons into an online storage medium in accordance with an aspect of the subject innovation.

FIG. 4 illustrates a further methodology of employing an online coupon store in accordance with an aspect of the subject innovation.

FIG. 5 illustrates a block diagram of a shopping network system that employs an online storage component, and combines coupon processing with payment processing.

FIG. 6 illustrates an exemplary packet formats for coupon files associated with an electronic coupon that is stored in the online storage component of the subject innovation.

FIG. 7 illustrates a particular payment processing entity that can further function as a coupon clearinghouse for transactions forwarded thereto.

FIG. 8 illustrates a payment processing entity that can interact with an online storage to access and process coupons regardless of which issuer has issued the coupon.

FIG. 9 illustrates a schematic block diagram of a suitable operating environment for implementing aspects of the subject innovation.

FIG. 10 illustrates a further schematic block diagram of a sample-computing environment for the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

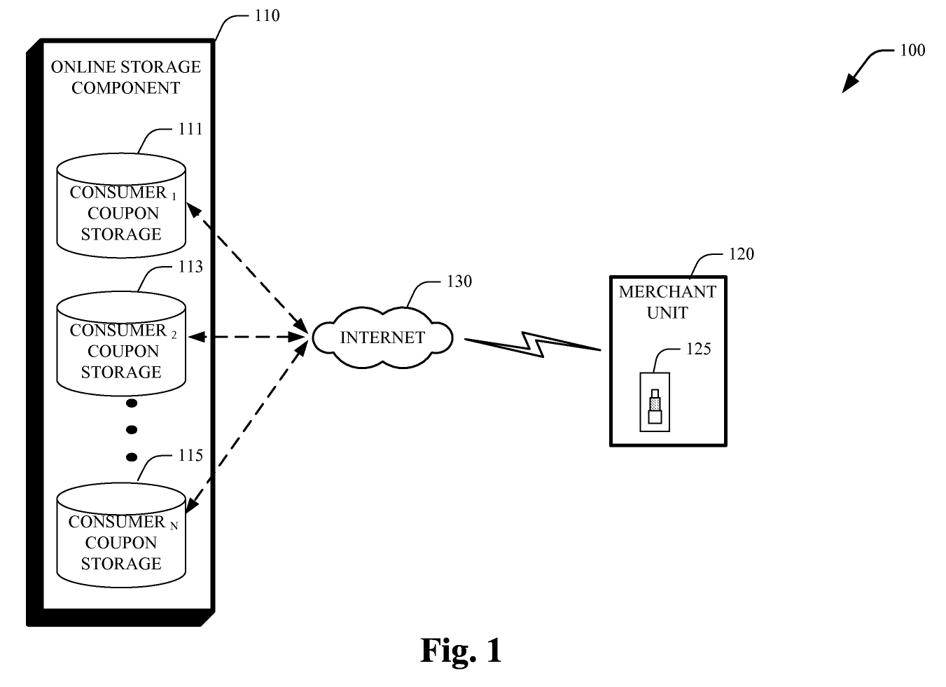

FIG. 1 illustrates a block diagram of a shopping network system 100 that employs an online storage component 110 in accordance with an aspect of the subject innovation. The shopping network system 100 redeems coupons, via an online storage component 110 that stores coupon data for a consumer and regardless of which issuer has issued the coupon. Accordingly, such online storage medium component 110 can store coupons online in storage mediums 111, 113, 115 (1 thru N, where N is an integer) that can represent a single location for each consumer. Such online storage component 110 can operate without being tied to a particular service, and can readily provide redemption (e.g., an automatic redemption). The consumer and other retail entities (e.g., coupon issuers, merchant units 120, and the like) can populate the online storage component periodically, or in response to predetermined events (e.g., physical location of consumer, associated demographics, and the like.) As illustrated, the merchant terminal 125 can be communicatively coupled to the merchant unit 120 via the internet 130. It is to be appreciated that users can directly access the online storage mediums for a populating thereof with coupons.

Moreover, the online storage component 110 can function as an online service, wherein users (e.g., consumers) can register therewith to store their coupons therein. Accordingly, the online storage component 110 can aggregate coupons collected from a plurality of channels (e.g., paper coupons, electronic coupons) therein—via submission thru the internet 130. Such service can organize collected coupons, facilitate a search thereof, and mange redemption and access to the collected coupons. During a purchase transaction, users redeem coupons that are related to the purchase via an identification process, wherein the terminal 125 (point of sale—POS) receives such coupons and can apply them to the user's shopping basket at checkout. Items in basket of the consumer can be matched with coupons stored for each respective client storage 111, 113, 115 and rules relating thereto (e.g., discourage using the coupons for the same identical transaction.)

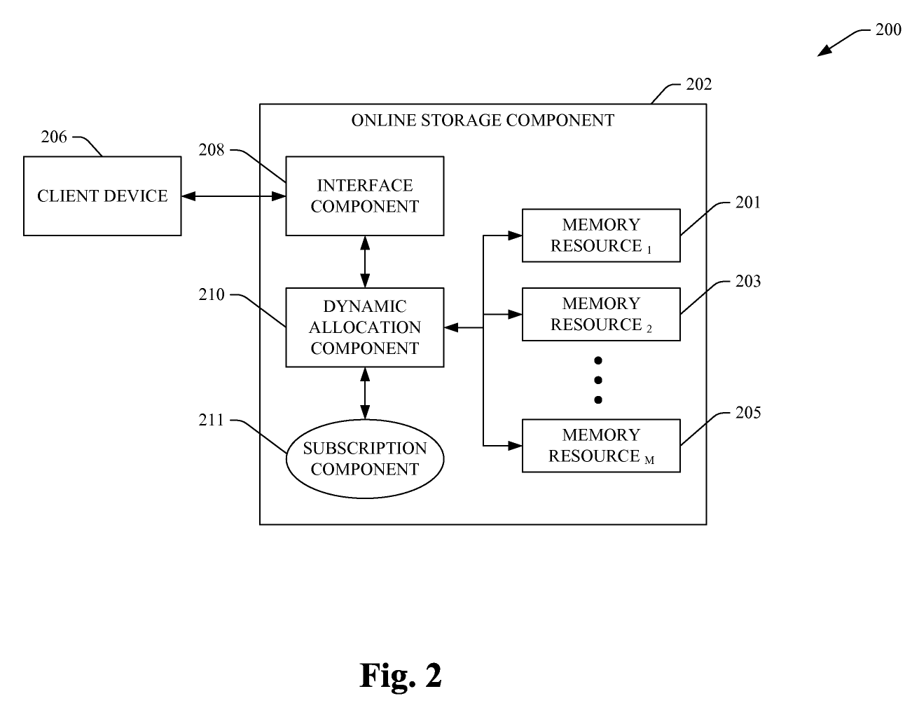

FIG. 2 illustrates a system 200 that facilitates allocation of various resource(s) of the online storage components based on requirements for coupon processing for each consumer. The online storage component 202 supports a collection of memory services software resources 201, 203, 205 (1 thru M, where M is an integer.) The memory resources 201, 203, 205 can be maintained by an off-premises party, and such resources can be accessed and employed by registered consumers over a network (e.g., Internet, WAN, and the like). Memory resources 201, 203, 205 can be centrally located and/or distributed at various geographic locations and can include any number of components that provide storage. Moreover, downtimes can be reduced by the online storage component 202 via utilizing any redundant resources—wherein, if a subset of the resources 201, 203, 205 are being updated or replaced, the remainder of such resources can be employed to service coupon processing requests from users. Such resources 201, 203, 205 can be modular in nature, and hence can be added, removed, tested, modified, etc. while the remaining resources can support coupon servicing user requests.

The client device 206 can represent intelligent devices (e.g., smart portable devices that can be carried by customers) with computing and processing capabilities, such as portable computers, personal digital assistants, mobile phones, digital music players and the like, which can further supply identifications and communicate with the online storage component 202. Moreover, the client device 206 can also represent other devices such: as kiosks; a point of sale (POS) unit associated with a merchant unit that can communicate therewith over a cell network, public wireless network, merchant's wired or wireless network or over a Bluetooth or NFC connection and the like, for example.

The merchant units and/or customers can subscribe to the online storage component 202 via an interface component 208. According to a particular example, disparate subscription levels can be offered in connection with memory resources 201, 203, and 205. For instance, a higher level subscription can provide increased processing power, bandwidth, storage capacity, services, and so forth as compared to a lower level subscription. Pursuant to a further example, each subscription level can provide a corresponding minimum level of resource assignment by the dynamic allocation component 210; however, if fewer requests by subscribers with high level subscriptions are obtained at a particular time, the dynamic allocation component 210 can alter the resource assignment above the minimum level. Further, subscriptions can be obtained for individual users and/or groups of users via the subscription component 211. Accordingly, the online storage component 202 can store coupons online (e.g., in a single location) without being tied to a particular service, and can readily provide redemption (e.g., an automatic redemption). The consumer and other retail entities (e.g., coupon issuers, merchants, and the like) can populate the online storage medium periodically, or in response to predetermined events (e.g., physical location of consumer, associated demographics, and the like.)

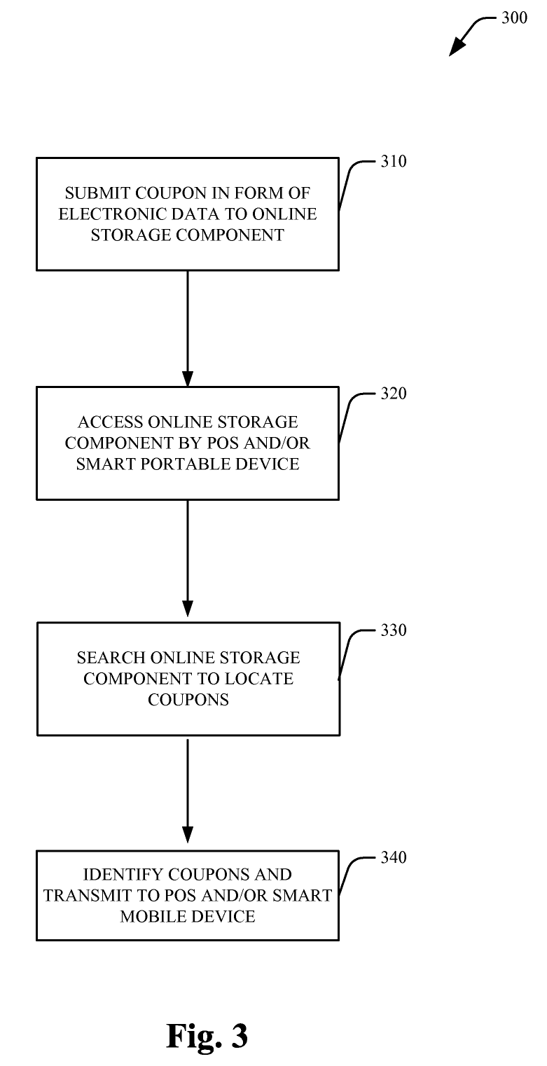

FIG. 3 illustrates a methodology 300 of aggregating coupons into an online storage medium in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 310, the user can submit coupons in form of electronic data to the online storage component. For example, paper coupons can be scanned via a scanner to form an electronic format, and subsequently submitted to the online storage component. The online storage component can store coupons online (e.g., in a single location) without being tied to a particular service, and can readily provide redemption (e.g., an automatic redemption). Next, and at 320 the online storage component can be accessed by a POS and/or a smart mobile unit that is carried by customers. At 330, a search of the online storage component can be performed to locate coupons related to a purchase transaction being processed by the POS, and/or customer. Next, and at 340 coupons can be identified and transmitted to the POS and/or smart mobile device carried by the customer. It is to be appreciated that other third party entities such as coupon i_{[0]}ssuers or distributers can also submit coupons to user's account, and such implementations are well within the realm of the subject innovation.

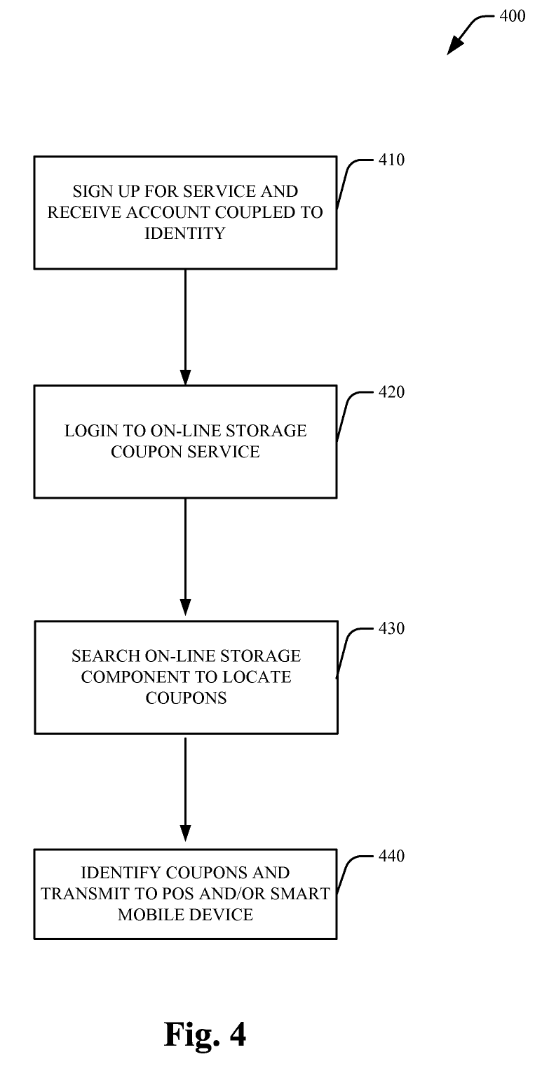

FIG. 4 illustrates a further methodology 400 of employing an online coupon store in accordance with an aspect of the subject innovation. Initially and at 410, users can sign up for such service and receive an account coupled to their identity (e.g., a user name, account number, password, and the like). Subsequently and at 420, users can login to the online storage coupon service with credentials from a web browser, desktop or mobile (cell phone) applications. Next and at 430, upon a successful login a user can view all coupons stored on the account organized by products, stores, expiration, and the like. Moreover, additional coupons can be stored by uploading an electronic coupon, image of a coupon (collected via smart phone's built-in camera), reading an RFID tag, and related methods of updating data. The service can keep track of submitted coupons, their expiration dates, automatically delete expired once and remind about those expiring soon. At 440, a request for a coupon related to a transaction can be supplied to the online storage component, and retrieved to be applied in the purchasing transaction.

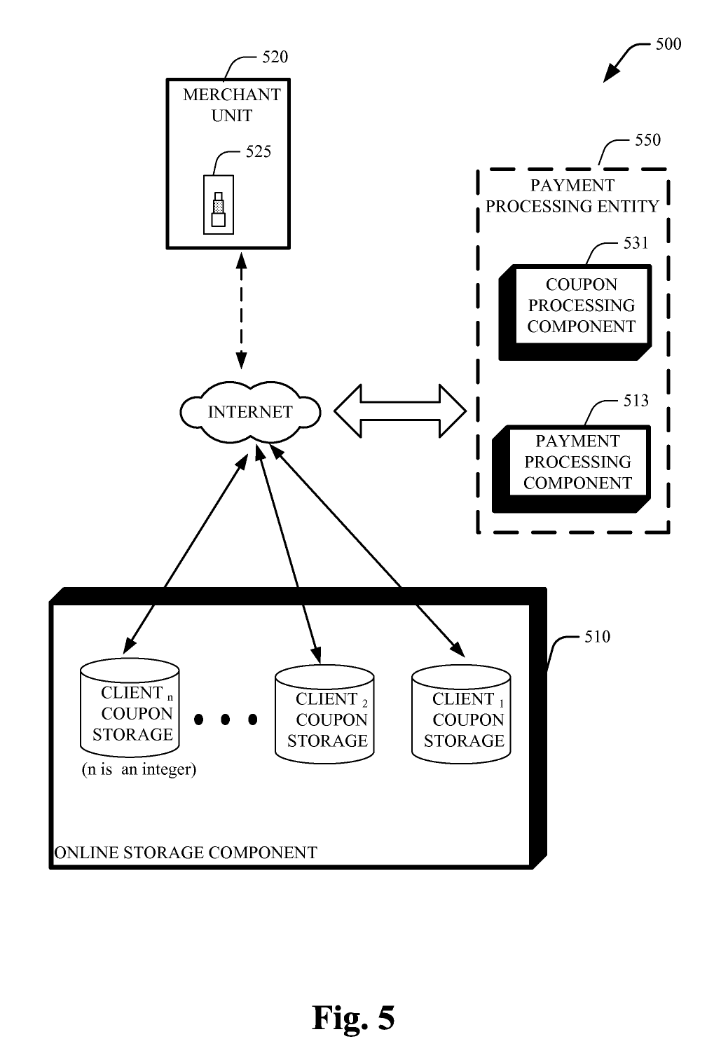

FIG. 5 illustrates a block diagram of a shopping network system 500 that employs an online storage component 510 and combines coupon processing with payment processing (e.g., a credit/debit card transaction). The payment processing entity 550 can function as the coupon ‘clearing house’ between coupon issuers and merchant units 520. Moreover, the shopping network system 500 can redeem coupons via the online storage component 510 that stores coupon data for a consumer and regardless of which issuer has issued the coupon.

In general, payment processing component 513 can settle charges with payment networks (e.g., Visa® and MasterCard®), as part of the payment processing entity 550 that integrates coupon processing with payment processing in accordance with an aspect of the subject innovation. Such payment processing entity 550 can typically serve as front end to the merchant unit 520.

For example, the merchant unit 520 can receive coupon data (e.g., from the online storage component 510) with payment information, and send such information as a single request to payment processing entity 550. The merchant unit 520 can further include: a central host computer operatively connected to a plurality of in-store customer sale terminals that can represent point of sale (POS); a wireless local area network that includes a plurality of access points; and a wired backbone for communicating data between the central host and the customer sale terminals (not shown). The customer sale terminals 525 can also receive each user's identification via a scan read, to access a respective online coupon account such as, for example, online coupon account number. The network can further include a plurality of manufacturer's servers, each corresponding to the manufacturer of a product available at the merchant's store. Each manufacturer's server can be communicatively coupled to the merchant's host via the internet, for example.

The merchant unit 520 can further accept coupon data via an intelligent device(s) that have downloaded coupons form the online storage component 5 10. Such intelligent device can include units such as mobile computer, personal digital assistant, cell phone and the like, which are carried by the customer, for example. The intelligent device can supply identifying information, coupon data and payment information to the online storage component 510 and/or merchant unit 520, via an exchange of information therewith. The coupon data can be processed by the coupon processing component 531, wherein coupon data can be cleared the respective manufacturer for reimbursement of the merchant (e.g., retailer.) Hence, an operation of the processing component 550 integrates both operations relating to payment processing and coupon clearance. It is to be appreciated that users can also access their online coupon accounts to print paper coupons therefrom. Such enables employing the subject innovation in conjunction with merchants that lack computer implemented processes. Moreover, the smart portable units carried by the users can further display coupons, for a machine scan by merchants (e.g., instead of scanning paper coupons.) In addition, coupons can be directly exchanged between the online storage and the POS terminal. The POS terminal can employ user credentials (e.g., account number) provided by users for accessing coupon accounts. Such credentials can be provided by a user's smart device or as data on a payment instrument such as magnetic stripe card or contact less card.

As such, the subject innovation can leverage the existing security protocols and payment processing infrastructure, to facilitate coupon processing. Moreover, existing trust relations that have been established can be employed (e.g., established relationships between banks, merchants, and payment processing entities.).

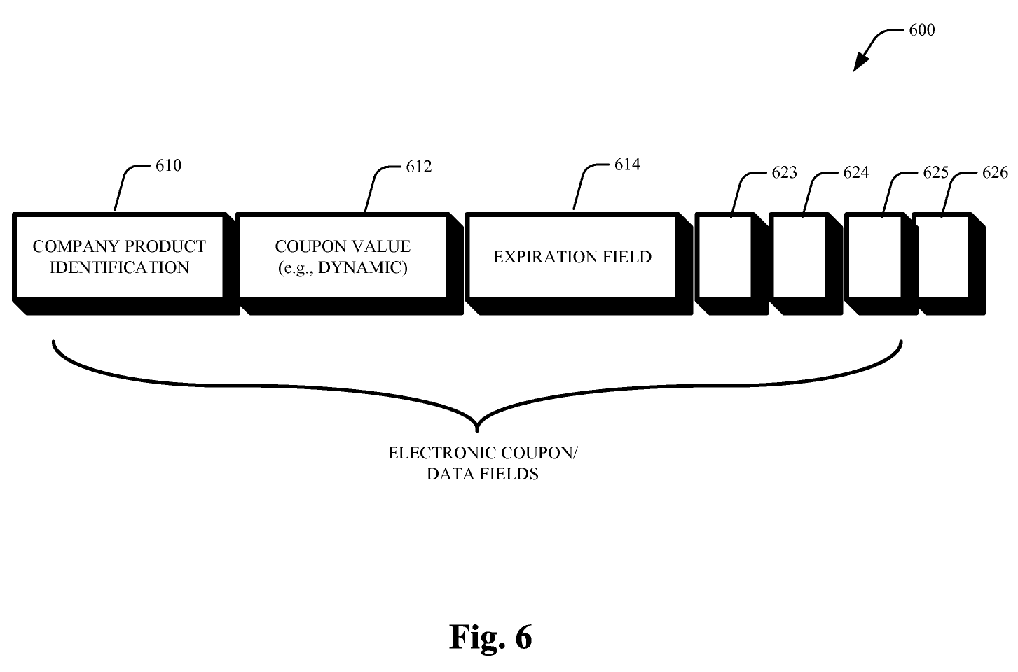

FIG. 6 illustrates an exemplary packet formats for coupon files associated with an electronic coupon that is stored in the online storage component of the subject innovation. The electronic coupon can be submitted by an intelligent device carried by a customer, or can be derived from a paper coupon via a scan thereof, for example. Associated data can include shopping list/purchase files and price look up files. The coupon file packet 610 can include company product identification, and a coupon value field 612, which can include information relating to the value of the coupon 600. The field 612 can include a formula for use in the case where the coupon value is dynamic in nature. An expiration field 614 can include data relating to when the coupon 600 expires. A bitmap icon field 623 includes data that can be used to generate an icon representing the product the coupon associated therewith. A manufacturer's website field 624 includes link information to the web site of the manufacturer that issued the coupon 600. A product data field 625 includes information relating the product the coupon is associated therewith. A date used field 626 includes data relating to when the coupon was actually used by the customer.

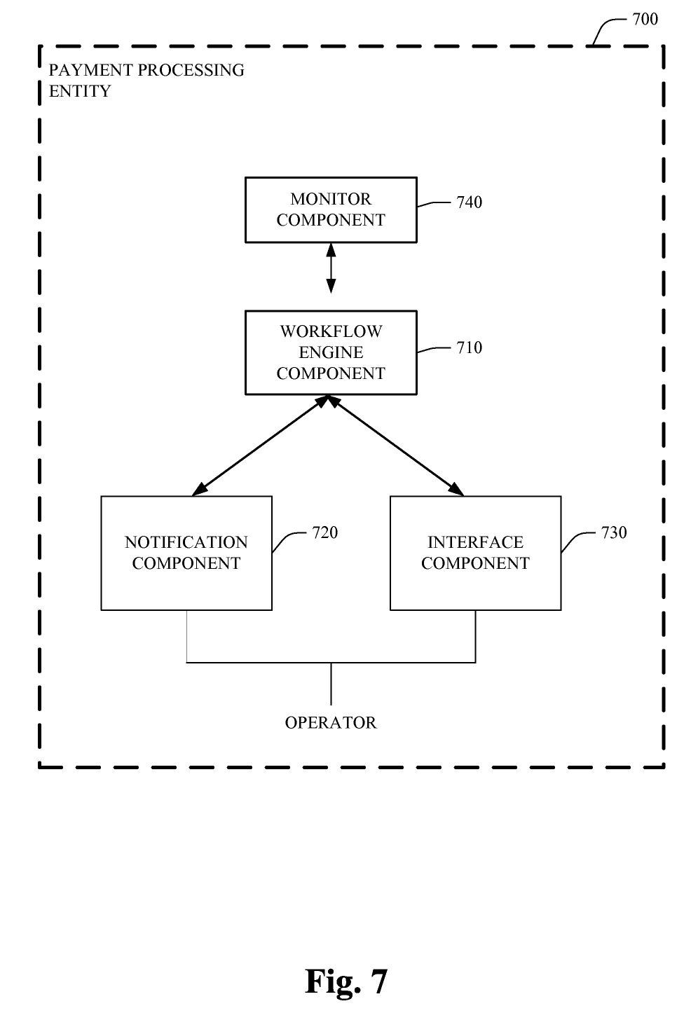

FIG. 7 illustrates a particular payment processing entity 700 that can further function as a coupon clearinghouse for transactions forwarded thereto. Such forwarded transactions can include a plurality of single requests, wherein each single request combines payment data together with coupon data that is downloaded from an online storage component, according to an aspect of the subject innovation. The payment processing system 700 can further include: a workflow engine component 710, a notification component 720, an interface component 730, and a monitor component 740. The workflow engine component 710 executes and manages workflow process instances. A workflow is a sequence or series of tasks used to manage and monitor processes, such payment processing and/or coupon settlement. Accordingly, an electronically redemption of coupons via an online storage location that stores coupon data for a consumer can be facilitated—regardless of which issuer has issued the coupon. The online storage medium can store coupons online (e.g., in a single location) without being tied to a particular service, and can readily provide redemption (e.g., an automatic redemption).

For example, a workflow instance can be instantiated for processing coupons downloaded from an online storage medium, and further integrate processes for coupon settlement and reimbursement with third parties (e.g., banks, coupon issuers and the like). The workflow engine component 710 can execute a series of tasks provided to it via a workflow instance associated with electronic coupon processing and payment processing. Tasks associated with the workflow can include creating a file, sending a file, retrieving a file, validating a file, reconciling a file, providing notification to a user or operator, retrieving information from a user or operator, and the like. The workflow engine component 710 can further employ a queue (not shown) to execute tasks with higher priority before tasks with lower priority, wherein tasks related to processing a coupon can be performed separate, or in conjunction with tasks for processing the payment.

Furthermore, when a workflow act or task requires operator input, workflow engine component 710 interacts with the notification component 720 to notify an operator that a related input is required. Such notification can employ a context analyzer (not shown) and statistical models to infer a best communication medium upon which to provide a notification (e.g., pop-up window, email, mobile phone, office phone, personal digital assistant (PDA), pager . . . ) to customers and/or operator of the POS terminal. Upon notification, an operator can communicate with the workflow execution engine via the user interface component 730. For example, the interface component 730 can be a graphical user interface (GUI) that facilitates interaction and transfer of information.

Payment processing system 700 also includes a monitor component 740, which monitors system resources to determine whether to increase the rate of executing tasks (e.g., from a queue), decrease the rate of tasks executing, or hold the rate of task execution at the same rate. This information can then be provided to the workflow engine component to effect the execution of payment processing tasks and coupon clearing tasks.

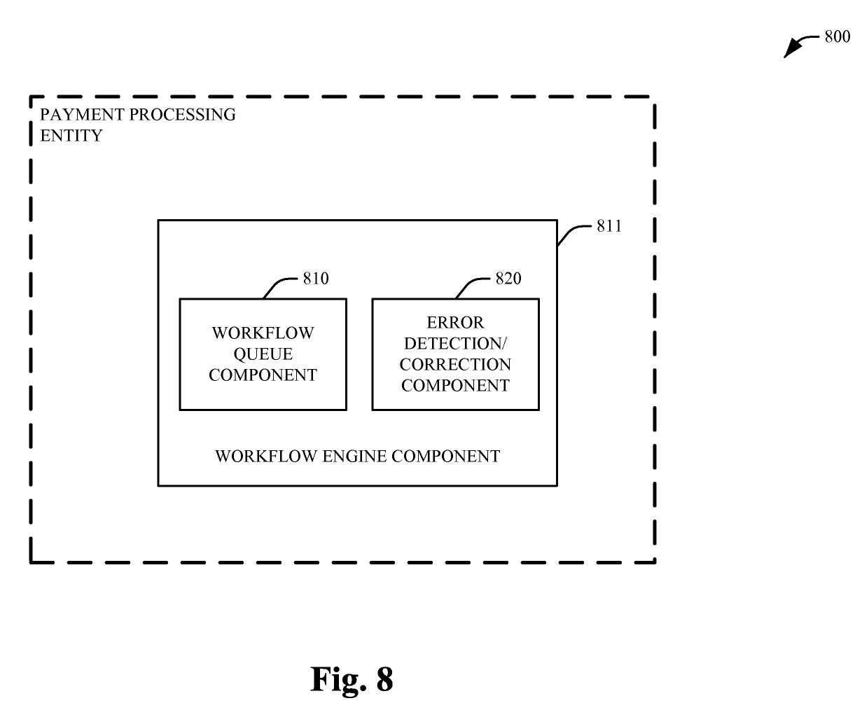

FIG. 8 illustrates a payment processing entity 800 that can interact with an online storage to access and process coupons regardless of which issuer has issued the coupon. The workflow engine component 811 further incorporates an error detection/correction component 820 as part of a coupon processing according to an aspect of the subject innovation. The workflow engine component 811 includes a workflow queue component 810 and an error detection component 820. As described supra, the workflow engine component 811 orchestrates the execution of workflow tasks. To enable efficient execution of tasks related to downloading coupons form the online storage and a processing thereof. Accordingly, a workflow queue component 810 can be employed, in the form of a database table, list, or stack that specifies the task execution order relative to other tasks, for example.

The workflow engine component 811 employs the workflow queue component 810 to facilitate execution of tasks in order of priority (e.g., highest priority to lowest priority). It is to be appreciated that the workflow engine component 811 can spread tasks over multiple computers having multiple processes with multiple threads and communicate via a network connection. Accordingly, increased efficiency in the execution of workflows can be accomplished by distributing workflows or workflow tasks amongst a plurality of workflow engine components 811 and/or computer systems for execution.

As illustrated, the workflow engine component 811 can further include an error detection/correction component 820 for detecting existence of error during execution of workflow tasks and facilitates easy recovery from an error resulting from among other things a system failure or a network failure. Upon the occurrence of, and detection of an error, the error detection/correction component 820 can compensate for such an error via check pointing, rollback schemes, and the like. For example, in a check pointing scheme a log file is maintained containing safe states. When problems occur, the workflow engine component 811 can restart task execution at the most recently available safe state. In a rollback scheme, effects of actions performed after the error and even before the error can be undone by applying corresponding reverse actions. It is to be appreciated that error avoidance schemes in form of error prediction and avoidance schemes can be employed by the error detection/correction component 820. For example, system stability can be analyzed by the error detection/correction component 820 using statistical methods, neural networks, experts systems and various other adaptive systems and components to predict within a particular threshold the failure of a workflow execution component or the computer system on which it is running. Subsequently, the tasks that were to be executed on the workflow engine component 811 are predicted to fail or otherwise encounter problems can be shifted to another workflow engine component 811 to mitigate problems.

As used in herein, the terms “component,” “system” and the like are intended to refer to a computer-related entity, either hardware, a combination of hardware and software, software or software in execution. For example, a component can be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

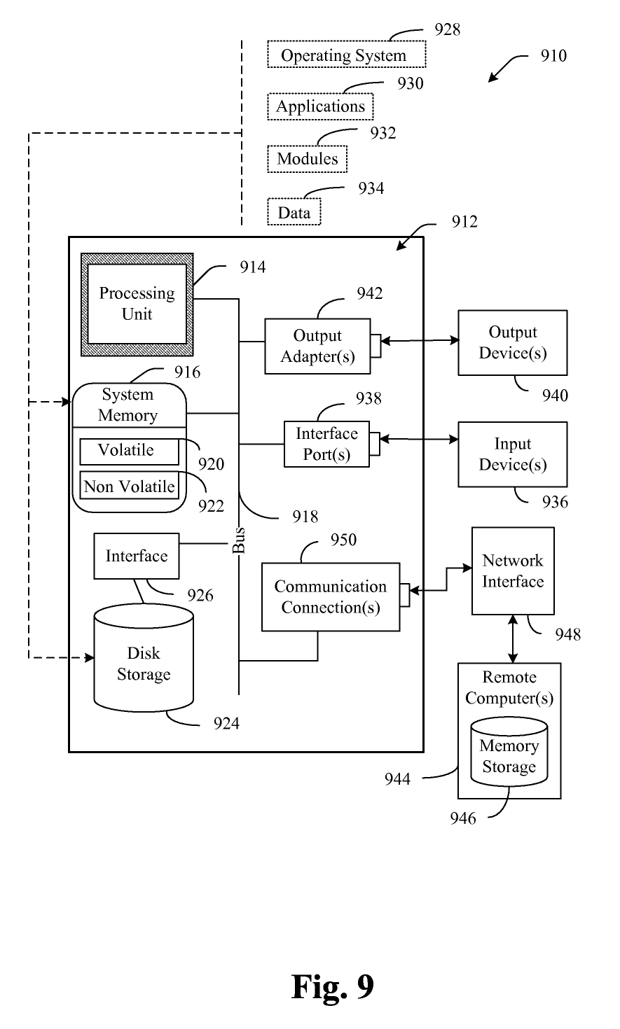

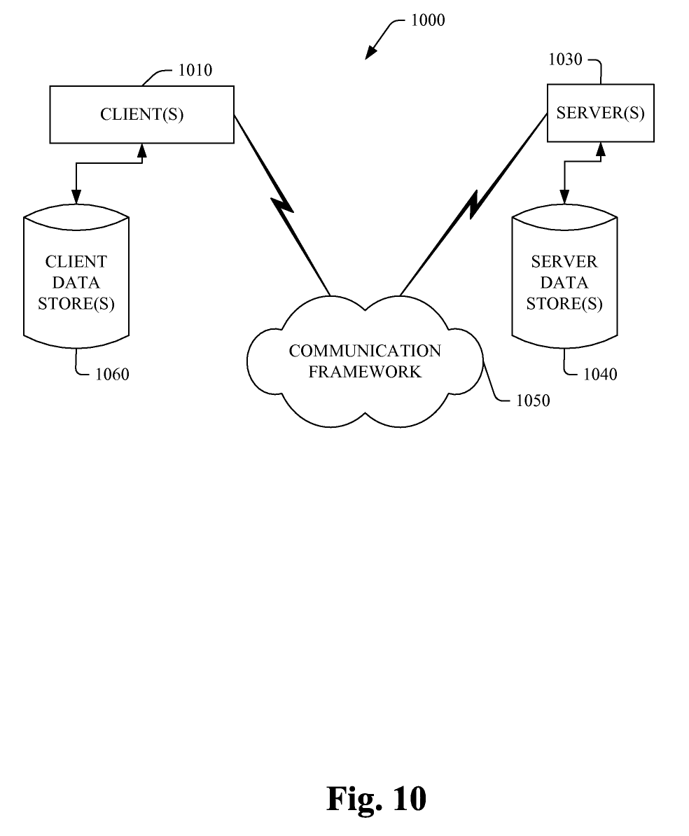

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed as part of an online storage and coupon processing system in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

1. A computer implemented system comprising:
an online storage component that stores coupon data for a consumer regardless of which issuer has issued a coupon; and
a point of sale terminal that receives a payment(s) from a customer and obtains the coupon from the online storage component.

2. The computer implemented system of claim 1 the online storage component as part of an online service.

3. The computer implemented system of claim 1 further comprising a mobile computing unit portable by the customer for identification thereof to the online storage component.

4. The computer implemented system of claim 1 further comprising a processing entity that processes the payment and the coupon data as part of an integrated processing operation.

5. The computer implemented system of claim 1 further comprising a workflow engine component that executes a workflow instance comprising a list of tasks related to processing payments and coupons.

6. The computer implemented system of claim 5, the work flow engine further comprising a queue to execute tasks according to priority.

7. The computer implemented system of claim 3 further comprising a monitor component that monitors system resources.

8. The computer implemented system of claim 3 further comprising an error detection component that detects existence of error during execution.

9. The computer implemented system of claim 4 further comprising a context analyzer to determine a communication process with an operator.

10. The computer implemented system of claim 5 further comprising a log file to restart execution of the workflow at a safe state.

11. A computer implemented method comprising:
storing coupon data for a consumer via an online storage component regardless of which issuer has issued coupons; and
receiving access requests to the online storage component for coupon redemption.

12. The computer implemented method of claim 11 further comprising redeeming a coupon via a processing entity.

13. The computer implemented method of claim 12 further comprising processing both a payment and clearing the coupon by the processing entity.

13. (canceled)

14. The computer implemented method of claim 11 further comprising forwarding a coupon to an issuing entity of the coupon.

15. The computer implemented method of claim 11 further comprising downloading a coupon from the online storage component to a smart portable unit carried by the consumer or to POS terminal.

16. The computer implemented method of claim 12 further comprising forwarding the coupon from a point of service terminal to the processing entity.

17. The computer implemented method of claim 11 further comprising changing a value of a coupon.

18. The computer implemented method of claim 12 further comprising forwarding a single request that contains payment data and coupon data to the processing entity.

19. The computer implemented method of claim 11 further comprising dynamically allocating resources of the online storage component.

20. A computer implemented system comprising:
means for storing coupon data regardless of which issuer has issued a coupon; and
means for integrating processing a payment and the coupon.
